(19) United States
(12) Patent Application Publication
(10) Pub. No.: US 2025/0157188 A1
(43) Pub. Date: May 15, 2025

(54) MEASURE SIMILARITIES BETWEEN SETS OF FEATURE VECTORS IN DEEP LEARNING APPLICATIONS

(71) Applicant: International Business Machines Corporation, Armonk, NY (US)

(72) Inventors: Parijat Dube, Yorktown Heights, NY (US); Bishwaranjan Bhattacharjee, Yorktown Heights, NY (US); Yulong Li, Westchester, NY (US); John Ronald Kender, Leonia, NJ (US)

(21) Appl. No.: 18/507,890

(22) Filed: Nov. 13, 2023

(51) Int. Cl. G06V 10/74; G06V 30/418

(52) U.S. Cl. CPC G06V 10/761; G06V 30/418

(57) ABSTRACT

A method, system and apparatus for measuring similarities between sets of feature vectors, including generating a feature representation from existing sources of datasets, generating representation of metric distances of the existing sources to each other using energy distance measure from the feature representation, generating feature representation of a target dataset, generating representation of the metric distances of each of the target dataset using the energy distance measure, and providing a choice of existing sources which further extremizes a geometric content of a hypervolume described by a pseudolabel sequence.

### CROSS REFERENCE TO RELATED APPLICATIONS

The present application is a related Application of co-pending U.S. patent application Ser. No. 17/705,595, IBM Docket No. P202008896US01, which is filed on Mar. 28, 2022, the entire contents of which are incorporated herein by reference.

### BACKGROUND

The present invention relates to an embodiment of a method, apparatus, and system for deep learning applications, and more particularly, but not by way of limitation, relates to a method, apparatus, and system for measuring similarities between sets of feature vectors in deep learning applications.

Deep learning is a type of machine learning based on artificial neural networks that use three or more layers to recognize patterns and features in data. Machines require input to be transformed or encoded into numbers to function. For example, vectors and matrices can be used to represent inputs like text and images as numbers, so that a model can be trained and implemented.

In machine learning, one of the goals is to create a model that performs some function. In deep learning models, this could be achieved through a neural network where the neural network layers use linear algebra, such as matrix and vector multiplication to adjust parameters. This is where vectors can be relevant for machine learning.

The output of machine learning models can be a range of different entities depending on the goal. If, for example, the goal is predicting stock or merchandise prices, the output can be a number. If on the other hand it is to classify images, the output can be a category of image. The output, however, can be a vector as well. For example, NLP (Natural Language Processing) models can accept text and then output a vector (called an embedding) representing the sentence. The vector can be used to perform a range of operations, or as an input into another model.

Additionally, in machine learning, data labeling is a process of identifying raw data (e.g., images, text files, videos, etc.) and adding one or more labels to provide context so that a machine learning model can learn from it. For example, labels might indicate whether an image may contain a person or a vehicle, which words were uttered in a voice recording, or if a medical image contains a broken bone. Data labeling is required for a variety of practical uses including natural language processing (NLP), computer vision, and speech recognition, etc.

In general, conventional data labeling is a cumbersome process of identifying and tagging unlabeled elements of a data set. A data set may include a vast array of images, audio recordings, text files, which can be, for example, millions or billions in number. If performed manually, a user individually labels each piece of data in a long process. If automated, the identification and tagging can use a labeling model. However, the conventional labeling models are difficult to train and generate.

Therefore, there is a need to have techniques that are more efficient to measure similarities in deep learning applications.

### SUMMARY

In view of the foregoing and other problems, disadvantages, and drawbacks of the aforementioned background art, an exemplary aspect of the disclosed invention provides a method, apparatus, and system for measuring similarities between sets of feature vectors in deep learning applications.

An embodiment of the present invention includes a method for measuring similarities between sets of feature vectors, including generating a feature representation from existing sources of datasets, and generating the metric distances of the existing sources to each other using an Energy Distance measure from the feature representation, together with generating a feature representation of a target dataset, and generating the metric distance of the targets to each other and to the sources using an Energy Distance measure from the feature representation.

In an embodiment of the present invention, a system for measuring similarities between a plurality of sets of feature vectors, includes a memory storing computer instructions, a processor executing the computer instructions and configured to generate a feature representation from existing sources of datasets, and generate the metric distances of the existing sources to each other using an Energy Distance measure from the feature representation, and to generate a feature representation from target datasets, and generate the metric distances generating the metric distance of the targets to each other and to the sources using an Energy Distance measure from the feature representation.

In another embodiment of the present invention, for measuring similarity between two sets of documents, the method includes calculating one or more contextualized token vector representations for two or more documents in a database, determining an internal energy of the two or more documents based on the one or more vector representations, calculating one or more contextualized token vector representations of a query, determining an internal energy of the query, calculating a cross energy of the query and the two or more documents, determining an energy distance based on the internal energy and cross energy of the query and the two or more documents, ranking the query and two or more documents by similarity based on the energy distance, and retrieving a document from the two or more documents based on the ranking.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

It is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The exemplary aspects of the invention will be better understood from the following detailed description of the exemplary embodiments of the invention with reference to the drawings.

FIG. 1 illustrates an example energy distance in Machine Learning (ML) applications.

FIG. 2 illustrates using energy distance in informal retrieval of an embodiment.

FIG. 3 in an exemplary embodiment depicts relationships between input images.

FIG. 4 illustrates deep learning pipeline for images in an exemplary embodiment.

FIG. 5 illustrates using Kullback-Leibler (KL) Divergence for distance Similarity measure.

FIG. 6 illustrates the steps of the method of an exemplary embodiment.

FIG. 7 illustrates Experiment Result 1: Best old vs. ED.

FIG. 8 illustrates Experiment Result 2: Fastest old vs. ED.

FIG. 9 illustrates Experiment Result 3: NLP vs. ED.

FIG. 10 illustrates an exemplary hardware/information handling system for incorporating the example embodiment of the present invention therein.

a) FIG. 11 illustrates a signal-bearing storage medium for storing machine-readable instructions of a program that implements the method according to the example embodiment of the present invention.

b) FIG. 12 depicts a cloud computing node according to an example embodiment of the present invention.

c) FIG. 13 depicts a cloud computing environment according to an example embodiment of the present invention.

FIG. 14 depicts abstraction model layers according to an example embodiment of the present invention.

FIG. 15 illustrates an exemplary hardware/information handling system for incorporating the example embodiment of the present invention therein.

### DETAILED DESCRIPTION

The invention will now be described with reference to the drawing figures, in which like reference numerals refer to like parts throughout. It is emphasized that, according to common practice, the various features of the drawing are not necessarily to scale. On the contrary, the dimensions of the various features can be arbitrarily expanded or reduced for clarity. Exemplary embodiments are provided below for illustration purposes and do not limit the claims. Moreover, please note that any of the steps can be performed in different sequences or combined or at the same time. In addition, any of the structures and embodiments shown can be modified or combined.

In an embodiment, a method to measure similarity between two sets using Energy Distance is shown below. This technique can be used in multiple fields including Vision and NLP, including finding pseudo labels for images, and in IR (Information Retrieval) modules of a Question Answering system. This technique is much better than previous work as shown by experimental results for Vision use cases provided.

A feature vector can be a numerical representation of a set of features or characteristics of an object or event. It represents input features to a machine learning model that can make a prediction.

Generally, Energy Distance can be defined as a statistical distance between two probability distributions. An example Energy Distance definition is as follows used in an embodiment.

A true metric, D, between labeled sets F and G, is defined as:

$${D}^{2} ( F , G ) = 2 E ‖ X - Y ‖ - E ‖ X - {X}^{′} ‖ - E ‖ Y - {Y}^{′} ‖$$

where X and X′ are in F, and Y and Y′ are in G, which can be interpreted as:
twice the average interdistance, minus the sum of the two average intradistances.

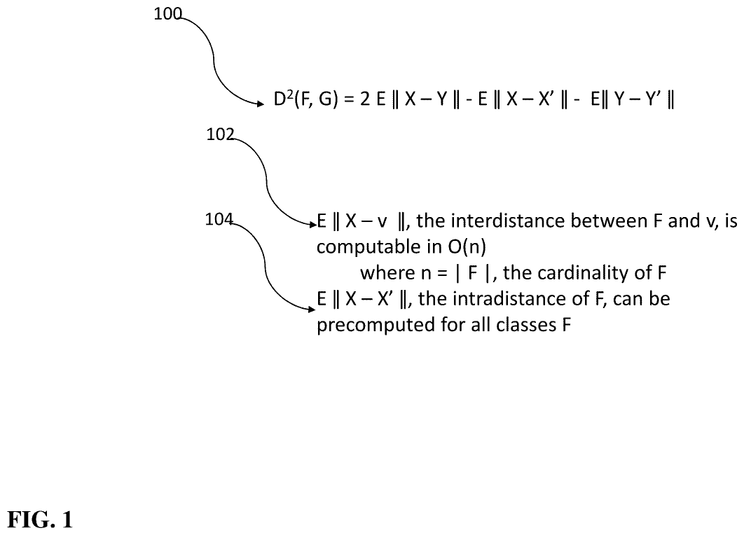

FIG. 1 illustrates an example energy distance in Machine Learning (ML) applications.

The Energy Distance in Machine Learning Applications is also valid when G is a singleton set, e.g., an incoming vector v to be labeled:

$${D}^{2} ( F , v ) = 2 E ‖ X - v ‖ - E ‖ X - {X}^{′} ‖ \qquad ( 100 )$$

E|X−v|, the interdistance between source F and target v, is computable in O(n), where n=|F|, the cardinality of F (102)
E|X−X′|, the intradistance of F, can be precomputed for all classes F

In this case, E|Y−Y′| is equal to zero, and can be omitted.

If needed, E|X−v| can be computed on a subsample of F (104).

Therefore, basically, the “target energy” is offset by “source energy”.

The Energy Distance in Transfer Learning and NLP (Natural Language Processing) can be used in G2L (Geometry to Label) for pseudo-labeling.

Transfer learning is a deep-learning technique that provides a solution to the problem of learning when human-annotated labels are expensive and limited. In place of such labels, it instead uses the previously trained weights from a well-chosen source model as the initial weights for the training of a base model for a new target dataset.

In the field of supervised deep learning, there can be an issue of not enough labeled training data as mentioned earlier. To remedy this issue, a technique of Transfer Learning uses trained weights from a source model as the initial weights for training a target dataset.

NLP is a machine learning technique and a branch of artificial intelligence that gives computers the ability to interpret, manipulate, and comprehend human language. NLP models work by finding relationships between the constituent parts of language.

The G2L approach in an embodiment for pseudo-labeling an image can be understood as being similar to the “Blind Men and the Elephant” parable, where blind men, who have never learned about an elephant, try to categorize an elephant just by touching it, then relating it to something that they already know. Their categorizations of Elephant then include Fan (ear), Rope (tail), Snake (trunk), Spear (tusk), Tree (leg), and Wall (flank). Basically, by touching and feeling an elephant, the blind men are measuring its closeness to things known by them. The approach of the embodiment also measures the closeness of an unknown image, in feature space, to existing known categories and then generates a pseudo-label for it.

G2L is based on a generalization of “volume” in high dimensions. The G2L core computation uses the Cayley-Menger (CM) determinant, which requires a metric. One can augment the “old” core G2L metric of distance-to-mean with the present “new” Energy Distance G2L distance-between-sets. Experiments show consistent improvements in accuracy of finding nearest neighbors.

In such a technique, first, one can take data points such as images, and compute labels for them by calculating distances of these data points from a set of named anchor data points representing known and labeled categories, like animal, plant, tool, etc. Second, pseudo-labels are then constructed for the incoming data points based on these distances, or, more accurately, based on the computation of “contents”, which is the high-dimensional generalization of distances, calculated using a geometric approach such as the CM determinant. Each pseudo-label then consists of a sequence of geometrically-chosen semantically descriptive names. For example, (tool, plant), could be the pseudo-label for data from a previously unseen category like rake. Finally, one can train a source model using these automatically generated labels.

One method compares unknown images to the existing categories that are nearest to them. Second, the method observes a strong predictive relationship between (a) the measurement of the similarity of unknown imagery to existing categories, and (b) the computation of a number of labels necessary to derive good transfer performance. Third, the method also observes a strong predictive relationship between measured similarity and optimal learning rate.

Generating rich labels from models trained on distributionally similar data involves a tradeoff between an expressive long label, and a generalizable short label. Longer labels carry more information about similarity between previous models and the target image, and differences between the previously trained models could be critical for adequately labeling new examples. For example, a novel set of data including pictures of household objects might be well described by combining the labels of “tool, fabric, furniture.”

However, domains that possess substantial differences from previous data might be better defined by the magnitude and direction of such a difference. For example, a “flower” dataset would share some features with “plant,” but it is perhaps better defined by statements such as “flowers are very unlike furniture”. In other, ambiguous cases, negative features may be necessary to distinguish between overlapping cases: a suit of armor might have similarities with the body shapes of people but could be contrasted with these categories by its dissimilarity with “sport,” a category otherwise close to “person.”

In the method, labels for a target dataset can be generated by using: first, a large labeled dataset preferably organized within a semantic hierarchy, such as ImageNet, and, second, a robust classifier, such as VGG16 trained on ImageNet. The robust classifier tool need not be trained on the labeled dataset tool itself. The labeled dataset can be partitioned into several non-intersecting subsets, each with a semantically meaningful name. For example, ImageNet can be partitioned into the 16 non-intersecting sets. The choice of a “good” partition necessarily is heuristic, particularly for target datasets from unusual domains.

The subsets that comprise the partition are referred to as the source subsets. A label for an incoming target data item is defined as the concatenation of some number of source subset names (or an encoding of this concatenation of names), such as the sequence <person, music, tool>. It is noted that this also produces an informative description of the incoming target data item. The choice of a “good” sequence length is again heuristic, but very short sequences would lead to underfitting models, and the reverse.

It is further noted that feature vector spaces used in machine learning are difficult to visualize, and such high-dimensional spaces generate geometric paradoxes even at relatively low dimensions. For example, each feature vector of a dataset is very likely to be on the convex hull of that dataset's representation in that space. Moreover, with increasing dimensions, the ratio of the distance to the farthest neighbor versus the distance to the nearest neighbor paradoxically tends to approach a value of 1. Nevertheless, although they are widely separated, particular “anchor” vectors can be used to represent other locations in these spaces (or their subspaces) by the well-studied method of barycentric coordinates.

As an example, if sources are sets of images of (A) apples, (B) banana, and (C) cantaloupes, the anchor points for apple, banana, and cantaloupe can be plotted in two-dimensions, based on size and roundness. The target image of a plantain can also be plotted by size and roundness, in order to determine the smallest geometric distance, where the size and roundness of the plantain are measured to be closest to the apple, the banana, or the cantaloupe. Based on this, the result could be that the plantain is closest to the banana. The best second choice could be the cantaloupe, since the triangle of plantain-banana-cantaloupe formed in this two-dimensional space makes the triangle with the smallest area. Therefore, the output label for cantaloupe is <B, C> (the input image looks more like a banana, and it is more cantaloupe-like than apple-like). Further dimensions can be added to size and roundness, such as color, and the method would then find which 3-dimensional tetrahedron has the smallest volume. Likewise, this method can be extended to seek the 4-dimensional pentachoron that extremizes its geometric content.

For example, if color is added, the method can determine if the plantain is closest to the color green. Or, a color can be added such as blue or red to determine that the plantain is farthest from that color (i.e., this represents the supposition that “I don't know what you are, but I know you are not red”). Then, in this case of three dimensions of size, roundness, and color, the method finds the smallest tetrahedron in order to label the input image.

In an example algorithm for automated data labeling using a geometric approach, the algorithm requires a number of hyperparameters that are set by experiment. An example is shown for each of these choices, in the pseudocode of the precondition (“require”) preamble. These examples use image classification as the domain, and they record the exact configuration that is used in the experiments reported in the rows. The indicator layer is the choice of a particular layer within the data representation of f, usually but not necessarily the second-to-last. The function Met is the choice of a distance function that has been derived from an inner product, as required for the derivation of CM (Cayley-Menger determinant).

The method Aggr is the choice of an aggregation method that represents a set of Layer vectors in a sparser form. This can be as trivial as using a single mean vector, or as more elaborate as using a set of representatives derived from clustering methods. The source food is probably adequately represented by a single aggregate vector, but the source fruit probably is better represented by a pair of aggregate vectors fruitₚₗₐₙₜ and fruit_{food}.

The integer dₘₐₓ determines the number of dimensions to be explored using CM during the creation of the output label name sequences. It also bounds the length of the name sequence plsᵢ, by dₘₐₓ≤|plsᵢ|≤2dₘₐₓ. The exact length of plsᵢ, which is constant over a given execution of the complete algorithm, is determined by Pol.

The extrema decision sequence Pol, and its summarizing notation, are best explained by a walkthrough of the algorithm. At d=1, the algorithm considers the length of the line (e.g., the 1-simplex) formed from the target data item tᵢ, and a representative vector sour_{j,k} from the source set representation Sourⱼ. If Aggr was a simple mean, then each Sourⱼ will be a singleton set. Each sour_{j,k} is examined, and the content computed by CM (here, the length), is recorded in cont_{i,j,k}.

Now, the first dimension's extremizing label sequence pls₁ for tᵢ can be selected, from one of four short sequences: (1) the source name of the closest vector, if Pol starts with <c>; or (2) the source name of farthest vector, if Pol starts with <f>; or (3) the source name of the closest vector followed by the source name of the farthest vector, if Pol starts with <C>; or (4) the source name of the farthest vector followed by the source name of the closest vector, if Pol starts with <F>.

For example, if Pol=<c>, one possible label pls₁ for a particular tᵢ could be the sequence <fruit_{food}> (e.g., with source fruit in the sense of food). Whereas, if Pol=<F>, it could be <fungus, fruit_{food}> instead. The four choices of extremizing policy at any dimension are therefore captured by the quaternary alphabet {c, f, C, F}. And in particular, the policy <C> forms labels consisting of the names of <closest, farthest> pairs.

Proceeding to d=2, the algorithm considers the areas, computed by CM, of the triangle (2-simplex) formed by the target data item tᵢ, a representative vector sour_{j,k}, and a single prior extremizing vector, chosen according to the first dimension's policy. This single vector would be the length-minimizing vector if the policy had been <c> or <C>; or the length-maximizing vector if the policy had been <f> or <F>. At this point, again one can efficiently choose one of four short sequences that capture the names of the area-extremizing sources for this dimension's label, which one then can append to the evolving label sequence plsᵢ.

The algorithm proceeds likewise for each higher dimension, up to dₘₐₓ, by first building simplices that extend the prior dimension's simplex, and then selecting names according to this higher dimension's policy.

The Energy Distance of an exemplary embodiment of the present invention in Transfer Learning and NLP can likewise be used in PrimeQA (Prime Repository for State-of-the-Art Multilingual Question Answering) for retrieval. PrimeQA is a public open source repository that enables researchers and developers to train state-of-the-art models for question answering (QA).

PrimeQA is based on the similarity of text embeddings. PrimeQA core computation uses cosine similarity, between parts of documents and queries.

The Energy Distance in Transfer Learning and NLP can augment “old” PrimeQA cosine-between-paragraphs with “new” PrimeQA energy-distance-between-entire-texts. The code changes to PrimeQA are small and localized.

An answer to why Energy Distance provides better “context” is shown as follows. Related signals tend to lie on a lower-dimensional manifold. Related images share color, texture, composition, background, etc. Related documents share words, sentence structure, semantic purpose, etc.

However, distances between manifolds need higher-order statistics including orientation, density, intersectionality, etc. These are difficult to define, compute, and illustrate (e.g., covariance matrices). However, Energy Distance captures some of these statistics, and performs it inexpensively.

Energy Distance for Similarity Measure in NLP is shown as follows. In NLP tasks such as information retrieval (IR), it is necessary to compare the similarity of a query with all documents from a database in order to retrieve the most relevant document.

The state-of-the-art method calculates a score based on the dot product of all query vectors and document vectors. The distribution of query and document vectors within its group is not considered.

$${S}_{q , d} := {\sum }_{i ∈ [ \vert {E}_{q} \vert ]} {max}_{j ∈ [ \vert {E}_{d} \vert ]} {E}_{qi} \cdot {E}_{{d}_{j}}^{T}$$

By taking into account the cross-energy and internal energy of query and documents, energy distance could complement existing methods with more information about context, and thus improve retrieval quality.

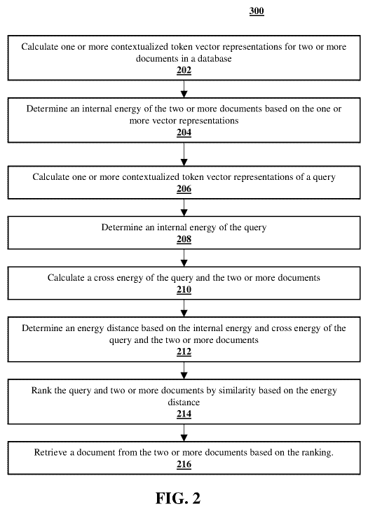

FIG. 2 illustrates using energy distance in informal retrieval of an embodiment.

The main example steps in an embodiment of using energy distance in IR is as follows with reference to FIG. 2.

In an embodiment, the method 200 calculates contextualized token vector representations of all documents in a database 202. This can be done offline.

The method 200 then calculates the “internal energy” of each document based on their vector representations 204. This can also be done offline.

The method 200 then calculates contextualized token vector representations of a query 206.

Then the method 200 calculates the “internal energy” of the query 208.

Then the method 200 calculates the “cross energy” of the query and each document 210.

Thereafter, the method 200 calculates the energy distance based on the internal energy and cross energy of query and each document 212.

Then, the method 200 ranks the similarity of query and documents based on their energy distance 214.

The document is retrieved from the two or more documents based on ranking 216.

Please note that the energy distance can be combined with other distance metrics (such as cosine distance) for ranking. Moreover, any of the method steps 200 can be performed in a different order or in parallel.

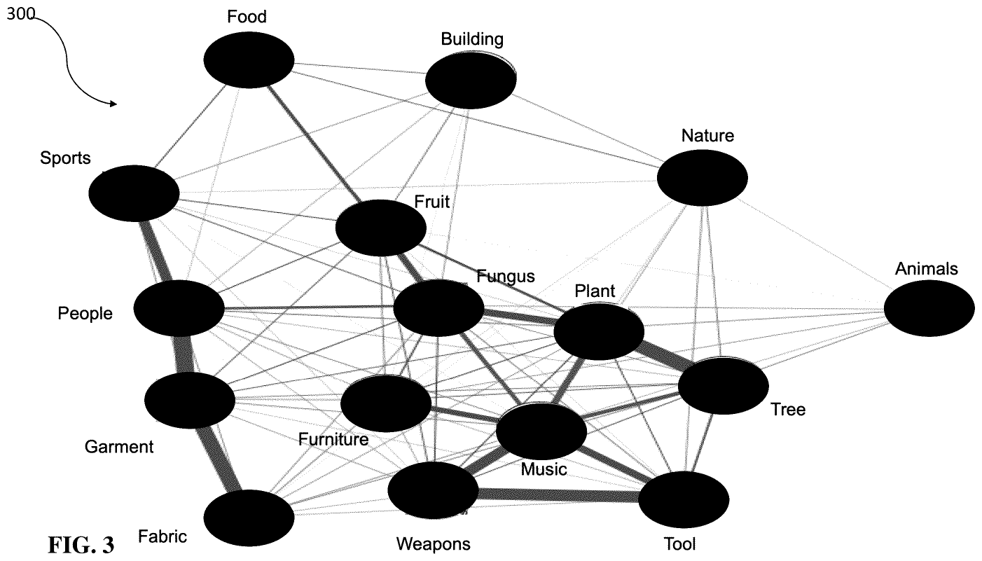

FIG. 3 in an exemplary embodiment depicts relationships between input images.

For example, for images, source datasets can be created by vertically partitioning ImageNet along these distinct subtrees 300: animal, building, fabric, food, fruit, fungus, furniture, garment, music, nature, person, plant, sport, tool, tree, weapon. They vary in their number of images and in their number of subclasses. These 16 sub-trees of ImageNet were used since they were easy to partition from ImageNet, but the method could also be used with a different selection. Each such dataset is represented by a single average feature vector. This study generates this vector from the second to last layer of a reference model. To label a new image, the exemplary embodiment can first calculate its own feature vector, then computes the distance between it and each of the representatives of the datasets. Together with geometric computations in this high dimensional space, these distance measures are then used for labeling purposes.

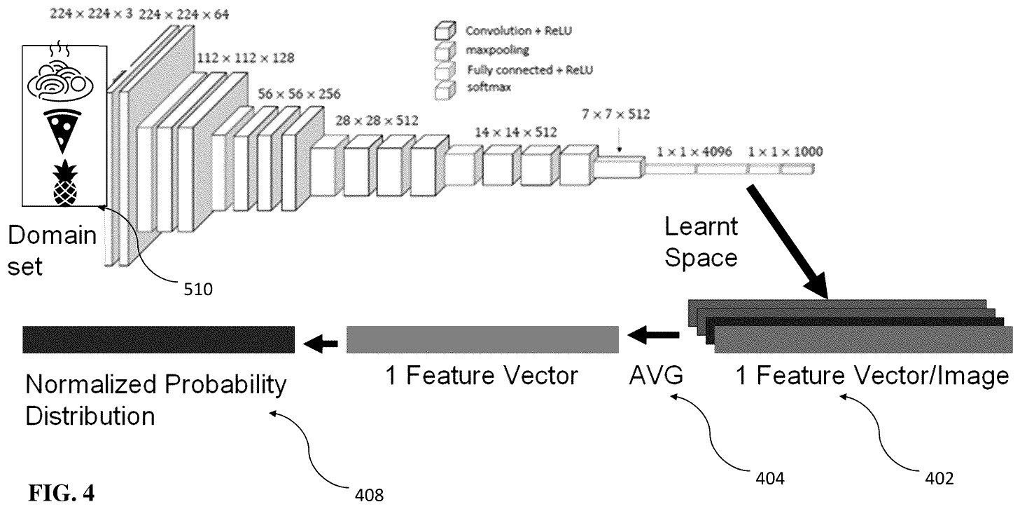

FIG. 4 illustrates deep learning pipeline for images in an exemplary embodiment.

As described in FIG. 4, a reference model is pre-trained on an image network. For F( ) the method first extracts the response of the penultimate full connection layer, usually a 4096-dimensional vector. In a learning task with k images 410, the method extracts k such vectors vᵢ, 402 compute their mean 404, v_{μ}, and then L1-normalizes this mean 408, giving v_{μ} as the summary feature vector for this task. For D(,), the method computes one of several possible distance measures, smoothing any zero components by adding an appropriate E value.

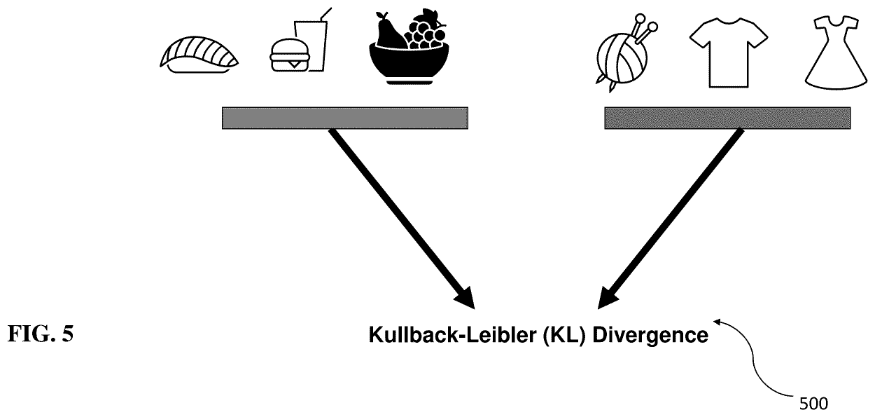

FIG. 5 illustrates using Kullback-Leibler (KL) Divergence to compute a similarity measure for selecting datasets that are sufficiently different from each other for the illustrated Experiments.

Divergence can be computed by first normalizing the representative vectors of each dataset so that their components (which are all non-negative) sum to 1, then applying the usual Kullback-Leibler divergence formula to generate an output 500. This can measure how one probability distribution diverges from a second probability distribution.

Since it is preferable to compare the performance of pseudo-labeling with respect to a baseline model using a reference dataset, one can select only those datasets whose transfer learning accuracy under the reference dataset were not close to 1, or those datasets whose KL divergence is sufficiently large. This ensures that the comparison with the reference dataset is not trivial.

Referring to FIGS. 3 and 5, task relationships can be shown. A simple measure based on KL divergence between dataset distributions can be performed. Experiments with ˜100 Tasks (image classification and sematic relation prediction) can be made.

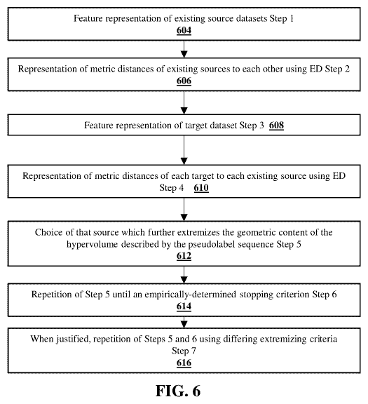

FIG. 6 illustrations steps of the method of an exemplary embodiment.

The example steps can be as follows:

Step 1: Feature representation of existing source datasets can be generated 604. The feature representations can be taken from a penultimate layer.

Step 2: Representation of metric distances of existing sources to each other using ED (Energy Distance) is generated 606.

Step 3: Feature representation of images in a target dataset is generated 608.

Step 4: Representation of metric distances of each target image to each existing source using ED is generated 610. Therefore, the method generates the metric distance of the targets to the sources using an Energy Distance measure from the feature representation.

Step 5: A choice of that source which further extremizes the geometric “content” of the hypervolume described by the pseudolabel sequence is provided 612.

Step 6: Repetition of Step 5 until an empirically-determined stopping criterion is performed 614.

Step 7: When justified, repetition of Steps 5 and 6 using differing extremizing criteria is performed 616.

The above steps can be performed in different sequences and some of the steps can be performed in parallel.

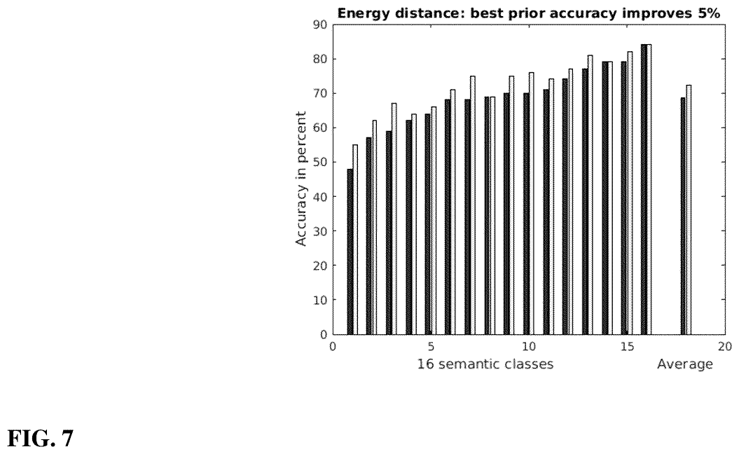

The initial Experiments are shown as follows with reference to FIG. 7 through FIG. 9.

In the tests, the Energy Distance is used to determine nearest neighbor. The data includes 100 random images each, from 16 semantic classes. The partition of ImageNet is again as follows: sport, tool, fruit, fabric, building, furniture, garment, music, nature, weapon, person, plant, tree, fungus, food, animal. The tests represent each image by the vector encoding from the second-last layer of a deep learning architecture.

The method in the tests tries various pre-normalizations, metrics, algorithms. The pre-normalization can be: none, L1 (sum=1), L2 (length=1), and the metric underlying the definition of distance can be: L1, L2.

Results from these tests show that ED improved average accuracy in all tests, and ED improved each individual accuracy in NLP test.

FIG. 7 illustrates Experiment Result 1: Best old method vs. ED.

In the experiment, pre-normalized by L2, distance defined by L2, and average accuracy is the following: old=68.7%, ED=72.3%. Therefore, the improvement=5.3%.

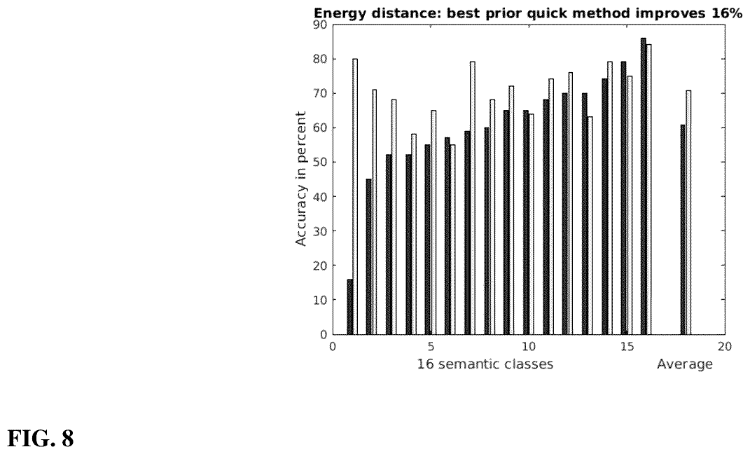

FIG. 8 illustrates Experiment Result 2: Fastest old method vs. ED.

In the experiment: no pre-normalization, distance defined by L1. The average accuracy is as follows: old=60.8%, ED=70.7%. Therefore, the improvement using ED=16.2%.

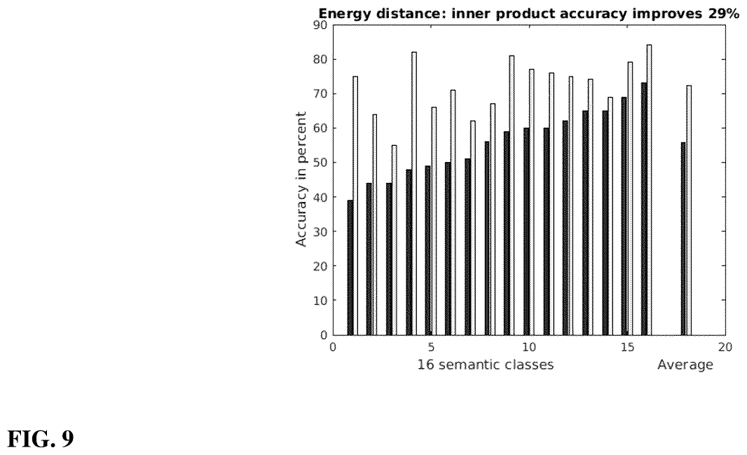

FIG. 9 illustrates Experiment Result 3: NLP vs. ED.

In the experiment: pre-normalized by L2, “distance” (more accurately, similarity) defined by cosine. The average accuracy is as follows: NLP=55.9%, ED=72.3%. Therefore, the improvement of using ED is =29.4%.

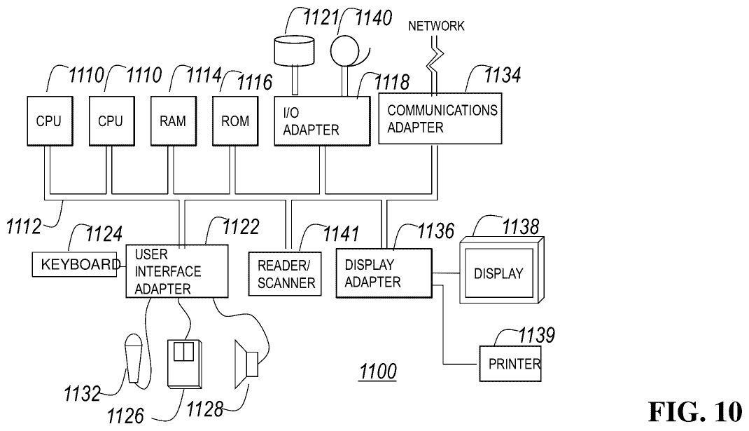

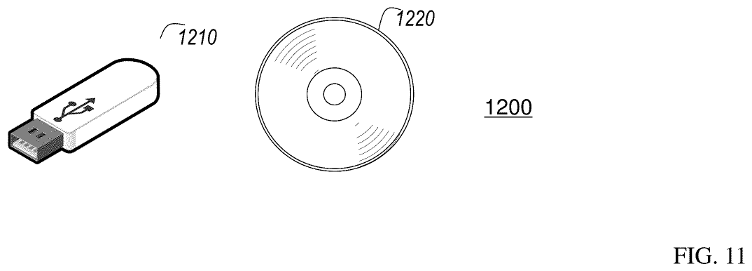

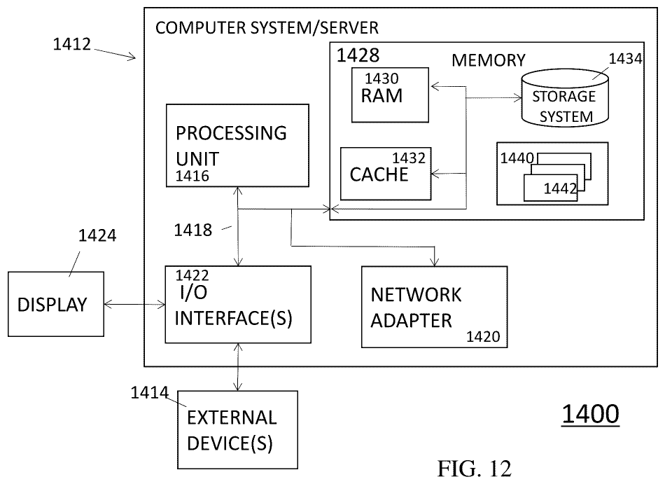

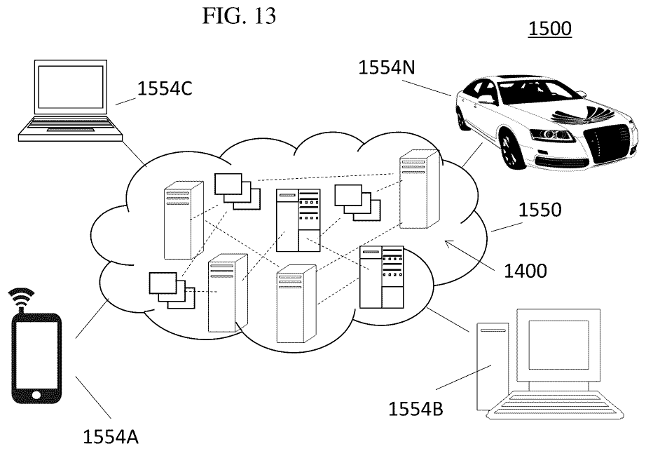

Different features shown in different figures above can be combined, changed or switched between the different examples. Any other configuration could be used. For example, the methods shown in FIGS. 2 and 6 can also be implemented in hardware and software shown in FIGS. 10 through 14.

FIG. 10 illustrates another hardware configuration of the system, where there is an information handling/computer system 1100 in accordance with the present invention and which preferably has at least one processor or central processing unit (CPU) 1110 that can implement the techniques of the invention in a form of a software program for software intelligence as-a-service.

The CPUs 1110 are interconnected via a system bus 1112 to a random access memory (RAM) 1114, read-only memory (ROM) 1116, input/output (I/O) adapter 1118 (for connecting peripheral devices such as disk units 1121 and tape drives 1140 to the bus 1112), user interface adapter 1122 (for connecting a keyboard 1124, mouse 1126, speaker 1128, microphone 1132, and/or other user interface device to the bus 1112), a communication adapter 1134 for connecting an information handling system to a data processing network, the Internet, an Intranet, a personal area network (PAN), etc., and a display adapter 1136 for connecting the bus 1112 to a display device 1138 and/or printer 1139 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including signal-bearing storage media tangibly embodying a program of machine-readable instructions executable by a digital data processor incorporating the CPU 1110 and hardware above, to perform the method of the invention.

This signal-bearing storage media may include, for example, a RAM contained within the CPU 1110, as represented by the fast-access storage for example.

Alternatively, the instructions may be contained in another signal-bearing storage media 1200, such as a flash memory 1210 or optical storage diskette 1220 (FIG. 11), directly or indirectly accessible by the CPU 1110.

Whether contained in the flash memory 1210, the optical disk 1220, the computer/CPU 1110, or elsewhere, the instructions may be stored on a variety of machine-readable data storage media.

Therefore, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

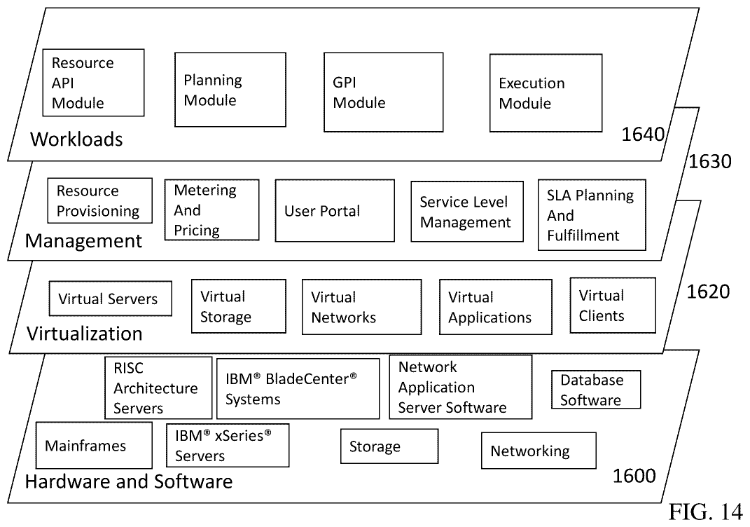

Referring now to FIG. 12, a schematic 1400 of an example of a cloud computing node is shown. Cloud computing node 1400 is only one example of a suitable cloud computing node and is not intended to suggest any limitation as to the scope of use or functionality of embodiments of the invention described herein. Regardless, cloud computing node 1400 is capable of being implemented and/or performing any of the functionality set forth hereinabove. As mentioned previously, methods of FIGS. 2 and 6 can be implemented in a cloud infrastructure such as FIG. 12 (and also FIGS. 13 and 14). In cloud computing node 1400 there is a computer system/server 1412, which is operational with numerous other general purpose or special purpose computing system environments or configurations. Examples of well-known computing systems, environments, and/or configurations that may be suitable for use with computer system/server 1412 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1412 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 1412 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 12, computer system/server 1412 in cloud computing node 1400 is shown in the form of a general-purpose computing device. The components of computer system/server 1412 may include, but are not limited to, one or more processors or processing units 1416, a system memory 1428, and a bus 1418 that couples various system components including system memory 1428 to processor 1416.

Bus 1418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 1412 typically includes a variety of computer system readable media. Such media may be any available media that is accessible by computer system/server 1412, and it includes both volatile and non-volatile media, removable and non-removable media.

System memory 1428 can include computer system readable media in the form of volatile memory, such as random-access memory (RAM) 1430 and/or cache memory 1432. Computer system/server 1412 may further include other removable/non-removable, volatile/non-volatile computer system storage media. By way of example only, storage system 1434 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1418 by one or more data media interfaces. As will be further depicted and described below, memory 1428 may include at least one program product having a set (e.g., at least one) of program modules that are configured to carry out the functions of embodiments of the invention.

Program/utility 1440, having a set (at least one) of program modules 1442, may be stored in memory 1428 by way of example, and not limitation, as well as an operating system, one or more application programs, other program modules, and program data. Each of the operating system, one or more application programs, other program modules, and program data or some combination thereof, may include an implementation of a networking environment. Program modules 1442 generally carry out the functions and/or methodologies of embodiments of the invention as described herein.

Computer system/server 1412 may also communicate with one or more external devices 1414 such as a keyboard, a pointing device, a display 1424, etc.; one or more devices that enable a user to interact with computer system/server 1412; and/or any devices (e.g., network card, modem, etc.) that enable computer system/server 1412 to communicate with one or more other computing devices. Such communication can occur via Input/Output (I/O) interfaces 1422. Still yet, computer system/server 1412 can communicate with one or more networks such as a local area network (LAN), a general wide area network (WAN), and/or a public network (e.g., the Internet) via network adapter 1420. As depicted, network adapter 1420 communicates with the other components of computer system/server 1412 via bus 1418. It should be understood that although not shown, other hardware and/or software components could be used in conjunction with computer system/server 1412. Examples, include, but are not limited to: microcode, device drivers, redundant processing units, external disk drive arrays, RAID systems, tape drives, and data archival storage systems, etc.

Referring now to FIG. 13, illustrative cloud computing environment 1550 is depicted. As shown, cloud computing environment 1550 includes one or more cloud computing nodes 1400 with which local computing devices used by cloud consumers, such as, for example, personal digital assistant (PDA) or cellular telephone 1554A, desktop computer 1554B, laptop computer 1554C, and/or automobile computer system 1554N may communicate. Nodes 1400 may communicate with one another. They may be grouped (not shown) physically or virtually, in one or more networks, such as Private, Community, Public, or Hybrid clouds as described hereinabove, or a combination thereof. This allows cloud computing environment 1550 to offer infrastructure, platforms and/or software as services for which a cloud consumer does not need to maintain resources on a local computing device. It is understood that the types of computing devices 1554A-N shown in FIG. 13 are intended to be illustrative only and that computing nodes 1400 and cloud computing environment 1550 can communicate with any type of computerized device over any type of network and/or network addressable connection (e.g., using a web browser).

Referring now to FIG. 14, a set of functional abstraction layers provided by cloud computing environment 1550 (FIG. 13) is shown. It should be understood in advance that the components, layers, and functions shown in FIG. 14 are intended to be illustrative only and embodiments of the invention are not limited thereto. As depicted, the following layers and corresponding functions are provided: Hardware and software layer 1600 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 1620 provides an abstraction layer from which the following examples of virtual entities may be provided: virtual servers; virtual storage; virtual networks, including virtual private networks; virtual applications and operating systems; and virtual clients.

In one example, management layer 1630 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 1640 provides examples of functionality for which the cloud computing environment may be utilized. Examples of workloads and functions which may be provided from this layer include such functions as mapping and navigation; software development and lifecycle management; virtual classroom education delivery; data analytics processing; transaction processing; and, more particularly relative to the present invention, the APIs and run-time system components of generating search autocomplete suggestions based on contextual input.

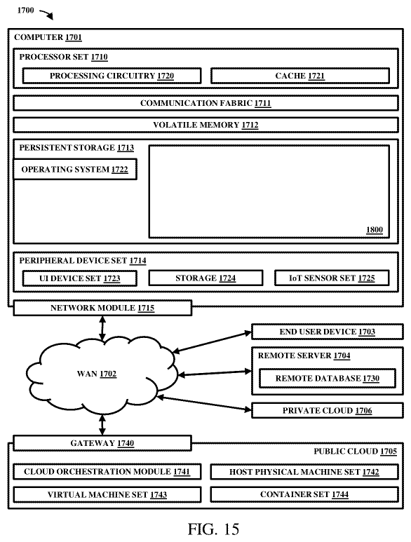

FIG. 15 illustrates an exemplary hardware/information handling system for incorporating the example embodiment of the present invention therein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1700 contains an example of an environment for the execution of at least some of the computer code involved in performing the inventive methods, such as the methods shown above in FIG. 2 in steps 202 to 216, and FIG. 6 in steps 604 to 616 in the methods to measure similarities between sets of feature vectors in deep learning applications (1800). In addition to block 1800, computing environment 1700 includes, for example, computer 1701, wide area network (WAN) 1702, end user device (EUD) 1703, remote server 1704, public cloud 1705, and private cloud 1706. In this embodiment, computer 1701 includes processor set 1710 (including processing circuitry 1720 and cache 1721), communication fabric 1711, volatile memory 1712, persistent storage 1713 (including operating system 1722 and block 1800, as identified above), peripheral device set 1714 (including user interface (UI) device set 1723, storage 1724, and Internet of Things (IoT) sensor set 1725), and network module 1715. Remote server 1704 includes remote database 1730. Public cloud 1705 includes gateway 1740, cloud orchestration module 1741, host physical machine set 1742, virtual machine set 1743, and container set 1744.

COMPUTER 1701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1730. As is well understood in the art of computer technology, and depending upon the technology, performance of a computer-implemented method may be distributed among multiple computers and/or between multiple locations. On the other hand, in this presentation of computing environment 1700, detailed discussion is focused on a single computer, specifically computer 1701, to keep the presentation as simple as possible. Computer 1701 may be located in a cloud, even though it is not shown in a cloud in FIG. 15. On the other hand, computer 1701 is not required to be in a cloud except to any extent as may be affirmatively indicated.

PROCESSOR SET 1710 includes one, or more, computer processors of any type now known or to be developed in the future. Processing circuitry 1720 may be distributed over multiple packages, for example, multiple, coordinated integrated circuit chips. Processing circuitry 1720 may implement multiple processor threads and/or multiple processor cores. Cache 1721 is memory that is located in the processor chip package(s) and is typically used for data or code that should be available for rapid access by the threads or cores running on processor set 1710. Cache memories are typically organized into multiple levels depending upon relative proximity to the processing circuitry. Alternatively, some, or all, of the cache for the processor set may be located “off chip.” In some computing environments, processor set 1710 may be designed for working with qubits and performing quantum computing.

Computer readable program instructions are typically loaded onto computer 1701 to cause a series of operational steps to be performed by processor set 1710 of computer 1701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1721 and the other storage media discussed below. The program instructions, and associated data, are accessed by processor set 1710 to control and direct performance of the inventive methods. In computing environment 1700, at least some of the instructions for performing the inventive methods may be stored in block 1800 in persistent storage 1713.

COMMUNICATION FABRIC 1711 is the signal conduction path that allows the various components of computer 1701 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1712 is any type of volatile memory now known or to be developed in the future. Examples include dynamic type random access memory (RAM) or static type RAM. Typically, volatile memory 1712 is characterized by random access, but this is not required unless affirmatively indicated. In computer 1701, the volatile memory 1712 is located in a single package and is internal to computer 1701, but, alternatively or additionally, the volatile memory may be distributed over multiple packages and/or located externally with respect to computer 1701.

PERSISTENT STORAGE 1713 is any form of non-volatile storage for computers that is now known or to be developed in the future. The non-volatility of this storage means that the stored data is maintained regardless of whether power is being supplied to computer 1701 and/or directly to persistent storage 1713. Persistent storage 1713 may be a read only memory (ROM), but typically at least a portion of the persistent storage allows writing of data, deletion of data and re-writing of data. Some familiar forms of persistent storage include magnetic disks and solid state storage devices. Operating system 1722 may take several forms, such as various known proprietary operating systems or open source Portable Operating System Interface-type operating systems that employ a kernel. The code included in block 1800 typically includes at least some of the computer code involved in performing the inventive methods.

PERIPHERAL DEVICE SET 1714 includes the set of peripheral devices of computer 101. Data communication connections between the peripheral devices and the other components of computer 1701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1723 may include components such as a display screen, speaker, microphone, wearable devices (such as goggles and smart watches), keyboard, mouse, printer, touchpad, game controllers, and haptic devices. Storage 1724 is external storage, such as an external hard drive, or insertable storage, such as an SD card. Storage 1724 may be persistent and/or volatile. In some embodiments, storage 1724 may take the form of a quantum computing storage device for storing data in the form of qubits. In embodiments where computer 1701 is required to have a large amount of storage (for example, where computer 1701 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 1715 is the collection of computer software, hardware, and firmware that allows computer 1701 to communicate with other computers through WAN 1702. Network module 1715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1715 are performed on the same physical hardware device. In other embodiments (for example, embodiments that utilize software-defined networking (SDN)), the control functions and the forwarding functions of network module 1715 are performed on physically separate devices, such that the control functions manage several different network hardware devices. Computer readable program instructions for performing the inventive methods can typically be downloaded to computer 1701 from an external computer or external storage device through a network adapter card or network interface included in network module 1715.

WAN 1702 is any wide area network (for example, the internet) capable of communicating computer data over non-local distances by any technology for communicating computer data, now known or to be developed in the future. In some embodiments, the WAN 1702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1703 is any computer system that is used and controlled by an end user (for example, a customer of an enterprise that operates computer 1701), and may take any of the forms discussed above in connection with computer 1701. EUD 103 typically receives helpful and useful data from the operations of computer 101. For example, in a hypothetical case where computer 1701 is designed to provide a recommendation to an end user, this recommendation would typically be communicated from network module 1715 of computer 1701 through WAN 1702 to EUD 1703. In this way, EUD 1703 can display, or otherwise present, the recommendation to an end user. In some embodiments, EUD 1703 may be a client device, such as thin client, heavy client, mainframe computer, desktop computer and so on.

REMOTE SERVER 1704 is any computer system that serves at least some data and/or functionality to computer 1701. Remote server 1704 may be controlled and used by the same entity that operates computer 1701. Remote server 1704 represents the machine(s) that collect and store helpful and useful data for use by other computers, such as computer 1701. For example, in a hypothetical case where computer 1701 is designed and programmed to provide a recommendation based on historical data, then this historical data may be provided to computer 1701 from remote database 1730 of remote server 1704.

PUBLIC CLOUD 1705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1705 is performed by the computer hardware and/or software of cloud orchestration module 1741. The computing resources provided by public cloud 1705 are typically implemented by virtual computing environments that run on various computers making up the computers of host physical machine set 1742, which is the universe of physical computers in and/or available to public cloud 1705. The virtual computing environments (VCEs) typically take the form of virtual machines from virtual machine set 1743 and/or containers from container set 1744. It is understood that these VCEs may be stored as images and may be transferred among and between the various physical machine hosts, either as images or after instantiation of the VCE. Cloud orchestration module 1471 manages the transfer and storage of images, deploys new instantiations of VCEs and manages active instantiations of VCE deployments. Gateway 1740 is the collection of computer software, hardware, and firmware that allows public cloud 1705 to communicate through WAN 1702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 1705, except that the computing resources are only available for use by a single enterprise. While private cloud 1706 is depicted as being in communication with WAN 1702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1705 and private cloud 1706 are both part of a larger hybrid cloud.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

It is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

What is claimed is:

1. A method for measuring similarities between sets of feature vectors, comprising:
generating a feature representation from existing sources of datasets;
generating representation of metric distances of the existing sources to each other using energy distance measure from the feature representation;
generating feature representation of a target dataset; and
generating representation of the metric distances of each of the target dataset using the energy distance measure.

2. The method according to claim 1, further comprising providing a choice of existing sources which further extremizes a geometric content of a hypervolume described by a pseudolabel sequence.

3. The method according to claim 2, further comprising repeating the providing of the choice until an empirically-determined stopping criterion is performed.

4. The method according to claim 3, further comprising repeating the providing of the choice using differing extremizing criteria.

5. The method according to claim 2, further comprising repeating the providing of the choice using differing extremizing criteria.

6. The method according to claim 2, wherein the target data set comprises images,
wherein the energy distance measure comprises a statistical distance between two probability distributions,
wherein the generating representation of the metric distances includes generating the metric distances of the targets to each other and to the sources using the energy distance measure from the feature representation.

7. The method according to claim 2, further comprising outputting pseudo labeling using the energy distance measure.

8. A computer readable medium storing instructions according to the method of claim 1.

9. A system for measuring similarities between sets of feature vectors, comprising:
a memory storing computer instructions;
a processor executing the computer instructions and configured to:
generate a feature representation from existing sources of datasets;
generate representation of metric distances of the existing sources to each other using energy distance measure from the feature representation;
generate feature representation of a target dataset; and
generate representation of the metric distances of each of the target dataset using the energy distance measure.

10. The system according to claim 9, wherein the processor is further configured to provide a choice of existing sources which further extremizes a geometric content of a hypervolume described by a pseudolabel sequence.

11. The system according to claim 10, wherein the processor is further configured to repeat the providing of the choice until an empirically-determined stopping criterion is performed.

12. The system according to claim 11, wherein the processor is further configured to repeat the providing of the choice using differing extremizing criteria.

13. The system according to claim 10, wherein the processor is further configured to repeat the providing of the choice using differing extremizing criteria.

14. The system according to claim 10, wherein the target data set comprises images,
wherein the energy distance measure comprises a statistical distance between two probability distributions, and
wherein the generating representation of the metric distances includes generating the metric distances of the targets to each other and to the sources using the energy distance measure from the feature representation.

15. The system according to claim 14, wherein the processor is further configured to outputting pseudo labeling using the energy distance measure.

16. A method for measuring similarity between two sets of documents, the method comprising:
calculating one or more contextualized token vector representations for two or more documents in a database;
determining an internal energy of the two or more documents based on the one or more vector representations;
calculating one or more contextualized token vector representations of a query;
determining an internal energy of the query;
calculating a cross energy of the query and the two or more documents;
determining an energy distance based on the internal energy and cross energy of the query and the two or more documents;
ranking the query and two or more documents by similarity based on the energy distance; and
retrieving a document from the two or more documents based on the ranking.

17. The method according to claim 16, wherein the ranking is further based on one or more distance metrics including cosine distance.

18. The method according to claim 16, wherein the method is performed offline.

19. A system, comprising:
a memory storing computer instructions; and
a processor executing the computer instructions comprising the method of claim 16.

20. A computer readable medium comprising computer instruction of the method of claim 16.
